(19) United States
(12) Patent Application Publication
(10) Pub. No.: US 2011/0002523 A1
(43) Pub. Date: Jan. 6, 2011

(54) Method and System of Segmenting CT Scan Data

(76) Inventors: Bhanu K. N. Prakash, Singapore (SG); Wieslaw Lucjan Nowinski, Singapore (SG)

Correspondence Address: FULBRIGHT & JAWORSKI L.L.P., 600 CONGRESS AVE., SUITE 2400, AUSTIN, TX, 78701, US

(21) Appl. No.: 12/921,141

(22) PCT Filed: Mar. 3, 2009
(86) PCT No.: PCT/SG09/00079

§ 371 Date: Sep. 3, 2010

Related U.S. Application Data
(60) Provisional application No. 61/033,105, filed on Mar. 3, 2008.

(51) Int. Cl. G06K 9/00

(52) U.S. Cl. 382/131

(57) ABSTRACT

A method of segmenting CT scan data comprises transforming intensity data into transformed data values. In a first option, the method includes convolving the CT scan data with a mask to obtain energy data wherein the mask has band pass filter characteristics, generating a histogram of the energy data and segmenting the CT scan data based on energy values in the generated histogram. In a second option, the method includes transforming the intensity data into Hounsfield scale data, and segmenting the image based on predefined Hounsfield scale values.

### FIELD OF THE INVENTION

The present invention relates to a method and system of segmenting CT scan data. The method and system can be used to remove skull regions in the CT scan data, identify hemorrhagic slices and segment hemorrhage regions in the hemorrhagic slices.

### BACKGROUND OF THE INVENTION

Cerebral strokes are one of the major causes of mortality and morbidity in many countries. Prompt assessment and treatment can help patients affected with cerebral stroke to recover some neurological functions that were lost during the acute phase of the stroke.

Computed Tomography (CT) can play an important role in the diagnosis of cerebral strokes. CT provides a very good contrast between the tissues and bones, as well as between the tissues and blood of a patient. Furthermore, CT is available in most hospitals and in emergency services. CT can also be used to distinguish between ischemic stroke and hemorrhage stroke, hemorrhage defined as the accumulation of blood inside the skull. There are many different types of hemorrhage, some of which are listed as follows: intraventricular hemorrhage (IVH), intracerebral hemorrhage (ICH), subarchnoid hemorrhage, subdural hematoma and epidural hematoma.

Segmentation is an important step in the analysis of many medical images, including CT images. In many classification processes, segmentation forms the first step. Segmentation can be useful in the diagnosis, quantitative evaluation and treatment of diseases. For example, the accurate segmentation of hemorrhage and hematoma regions can aid clinicians [1, 2 and 3] in obtaining structural information and quantification and in planning treatment. Accurate segmentation techniques can also aid the clinician in classifying different types of hemorrhage and thus can allow the clinician to make quick and relevant clinical decisions in the context of thrombolysis or in treatment plans [4].

Since manual segmentation is tedious, time consuming and subjective (inter observer variability is around 1.7-4.2%), attempts have been made to automatically classify and quantify healthy and diseased tissues and organs from images obtained by various medical imaging modalities. However, segmentation of medical images is a challenging task because of the complexity of the images and the absence of anatomy models that can fully capture the possible deformations in each structure. This is made more difficult by the relatively low signal to noise ratios and inherent artifacts generally present in medical images. Because of these problems, even though there have been many segmentation algorithms reported, most of these algorithms have inconsistent results and/or limited applications. Thus, only a few computer aided detection (CAD) algorithms are being used in clinical practice.

An accurate, robust and quick segmentation of CT data is thus required to aid clinicians in the interpretation and morphological measurements of CT images and in decision making.

### SUMMARY OF THE INVENTION

The present invention aims to provide new and useful segmentation systems for segmenting CT scan data.

In general terms, the present invention proposes that scan images composed of intensity data are processed by transforming the intensity data, and the transformed data are windowed using thresholds to exclude portions of the image of low interest.

In one example, the windowed data may be segmented to produce a mask, and that the mask is used to segment the data by multiplying the mask with the scan image, or the transformed data.

In a first aspect of the invention, the transformed data is produced according to a Law texture mask to give transformed data values (which in Laws terminology are called “energy values”). The Law texture mask is implemented by a convolution with a matrix representing a band pass filter in the spatial frequency domain.

In a second aspect of the invention, the transformed data is transformed according to a Hounsfield scale, and the threshold values are selected according to predefined Hounsfield scale values.

The invention may be expressed in terms of a method, or alternatively as a computer system for performing such methods. The computer system may be integrated with a device for obtaining the CT scan data. The invention may also be expressed as a computer program product, such as one recorded on a tangible computer medium, containing program instructions operable by a computer system to perform the steps of the methods.

### BRIEF DESCRIPTION OF THE FIGURES

An embodiment of the invention will now be illustrated for the sake of example only with reference to the following drawings, in which:

FIG. 1 illustrates a flow diagram of a first embodiment of the invention which is a method 100 which removes portions of the CT scan data corresponding to the skull for slices of the CT scan volume not near the posterior fossa;

FIG. 2(a)-(e) illustrate an original CT scan image and the results of applying method 100 on the original CT scan image;

FIG. 3 illustrates a flow diagram of a second embodiment of the invention which removes portions of the CT scan data corresponding to the skull for slices of the CT scan volume not near the posterior fossa;

FIG. 4(a)-(c) illustrate an original CT scan image and the results of applying steps 302 and 304 of method 300 on the original CT scan image;

FIG. 5(a)-(d) illustrate the windowed intensity image obtained from step 302 in method 300 and the energy image obtained from step 304 in method 300, together with their respective Fourier magnitude spectrums;

FIG. 6 illustrates one example of the smooth histogram obtained from step 306 in method 300;

FIG. 7(a)-(f) illustrate an original CT scan image and the results of applying method 300 on the original CT scan image;

FIG. 8 illustrates a flow diagram of an example of a method 800 which removes portions of the CT scan data corresponding to the skull for slices of the CT scan volume near the posterior fossa, and which is useful in the embodiments of FIGS. 1 and 3;

FIG. 9(a)-(e) illustrate the windowed intensity images of two slices of the CT scan volume near the posterior fossa and the results of applying method 800 on these slices;

FIG. 10 illustrates a flow diagram of a further embodiment of the invention which is a method 1000 which identifies and segments hemorrhagic slices in the CT scan volume;

FIG. 11 illustrates the Hounsfield scale of CT numbers for different tissue types;

FIG. 12 illustrates a flow diagram of a further embodiment of the invention which is a method 1200 which identifies and segments hemorrhagic slices in the CT scan volume;

FIG. 13 illustrates one example of the smooth histogram obtained from step 1208 in method 1200;

FIG. 14(a)-(e) illustrate an original CT scan image and the results of applying method 1200 on the original CT scan image;

FIG. 15 illustrates a flow diagram of a further embodiment of the invention which is a method 1500 which segments hemorrhagic slices in the CT scan volume;

FIG. 16(a)-(f) illustrate the results of applying method 1500 on a first hemorrhagic slice of a CT scan volume;

FIG. 17(a)-(f) illustrate the results of applying method 1500 on a second hemorrhagic slice of a CT scan volume;

FIG. 18 illustrates a flow diagram of a method 1800 which can be employed in certain of the embodiments and segments the catheter region;

FIG. 19(a)-(g) illustrate an original CT scan image and the results of applying method 1800 on the original CT scan image;

FIG. 20(a)-(e) illustrate the intensity image of a slice of a CT scan volume and the histogram of the intensity image;

FIG. 21(a)-(e) illustrate the energy image of a slice of a CT scan volume and the histogram of the energy image.

### DETAILED DESCRIPTION OF THE EMBODIMENTS

### Method 100: First Example of a Skull Removal Method for Slices not Near the Posterior Fossa

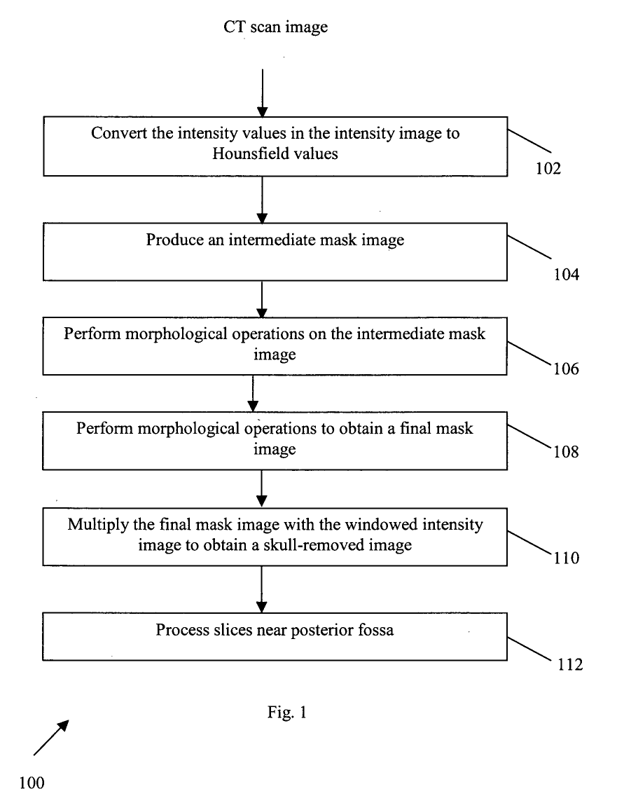

Referring to FIG. 1, the steps are illustrated of a method 100 which is a first embodiment of the invention. The method removes portions of the CT scan data corresponding to the skull for slices of the CT scan volume.

The input to method 100 is a plurality of slices of a CT scan volume (i.e. a CT scan image). In one example, each CT scan image is in the DICOM format. The set of steps 102 to 110 is then performed for each slice individually. Alternatively, steps 102 to 110 can be performed directly on the CT scan volume.

In method 100, steps 102 to 110 are performed only on slices which are not near the posterior fossa. In this specification, slices near the posterior fossa are defined as the two to three slices nearest the posterior fossa.

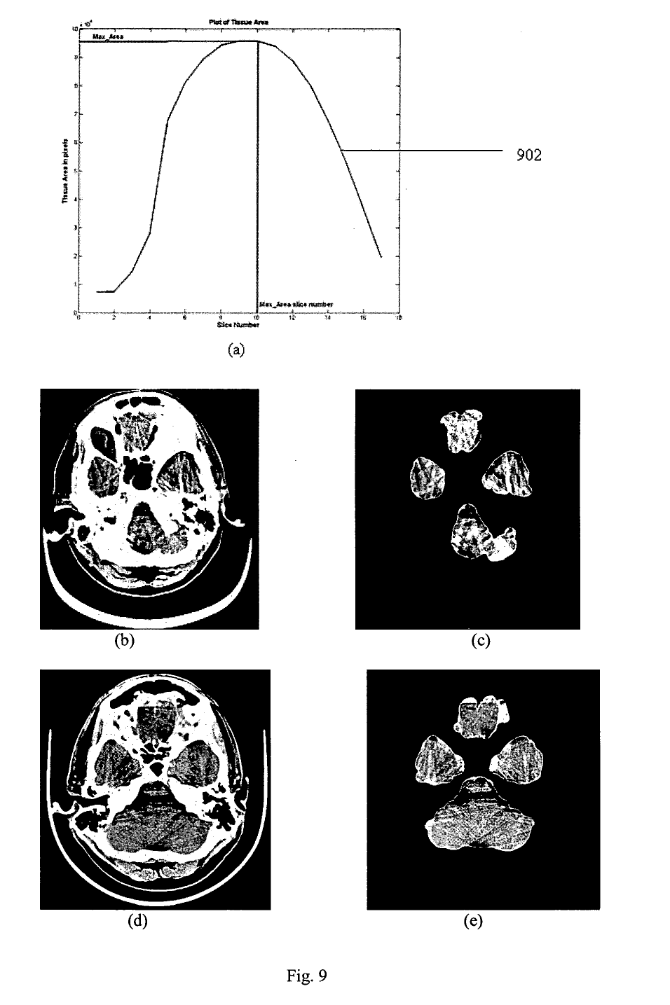

In one example, the CT scan is assumed to be performed starting from the posterior fossa to the top of the head since this is usually the case according to radiological convention. Therefore, the initial two to three slices of the scan are taken to be slices near the posterior fossa. In another example, slices near the posterior fossa are determined based on the shape of the tissue area to slice number graph as shown in FIG. 9(a) since the shape or cross-sectional area of the brain at the top is different from the shape or cross-sectional area of the brain at the posterior fossa. Alternatively, the posterior fossa is located by locating the pineal body in the brain or by its Talairach coordinates and the two to three slices nearest the posterior fossa are taken to be slices near the posterior fossa.

In step 102, the intensity values in the intensity image are converted to Hounsfield values according to Equation (1) using values of two parameters “Slope” and “Intercept” which are imported from the DICOM file. In one example, the “Slope” and “Intercept” values are such that the transformation in Equation (1) amounts to the typical Hounsfield transformation in which the Hounsfield value is calculated according to (μ_{X}−μ_{H2O})/(μ_{X}−μ_{H2O})*1000 whereby μ_{X}, μ_{H2O} and μₐᵢᵣ are respectively the linear attenuation coefficients of the targeted material, water and air.

Hounsfield value=Intensity value*Slope+Intercept (1)

In step 104, an intermediate mask image is obtained by thresholding the intensity image, i.e. deleting all but the values between an upper limit (i.e. threshold) and a lower limit. In one example, the upper and lower limits are set as 400 HU and 90 HU respectively. These upper and lower limits are selected using knowledge of the typical range of Hounsfield values of bone. The result is referred to as an intermediate mask image.

In step 106, a first morphological operation (opening) is performed on the intermediate mask image using a suitable structuring element so as to remove the unwanted connections between the skull and the brain tissue. In example embodiments, the structuring element can be of any shape, for example circle, square, rectangle, diamond or disk.

In step 108, further morphological operations (dilation and image filling) are then performed to restore the tissue region inside the skull to obtain a final mask image.

In step 110, the final mask image is multiplied with the windowed intensity image produced in step 104 to obtain an image with the skull removed (i.e. a skull-removed image). This is equivalent to a logical AND operation between the final mask image and the windowed intensity image.

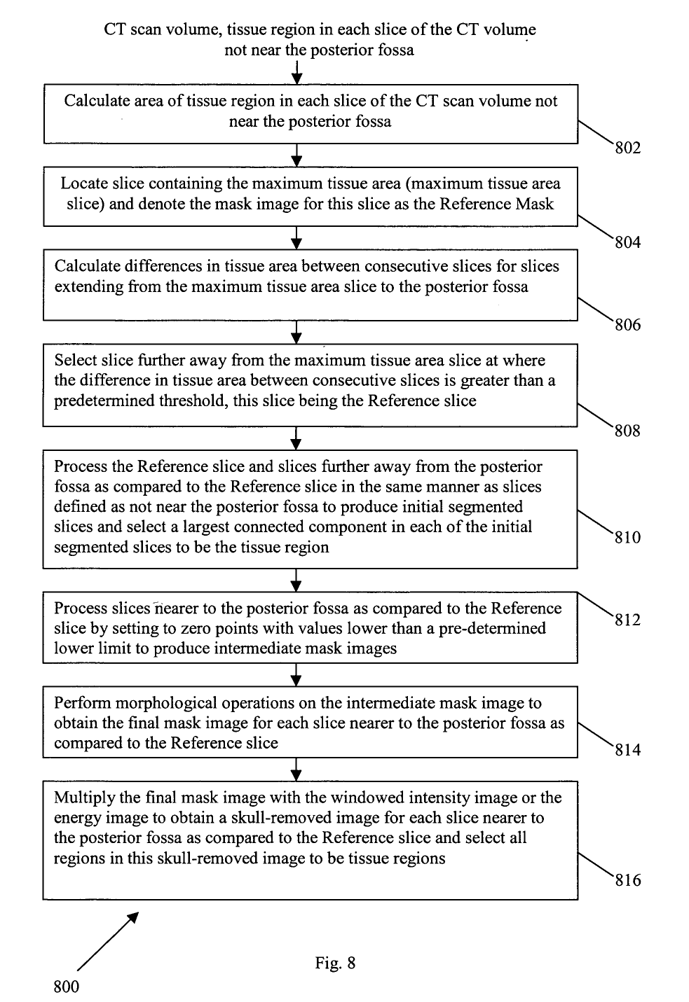

Finally, in step 112 slices near the posterior fossa are processed by a process described below with reference to FIG. 8.

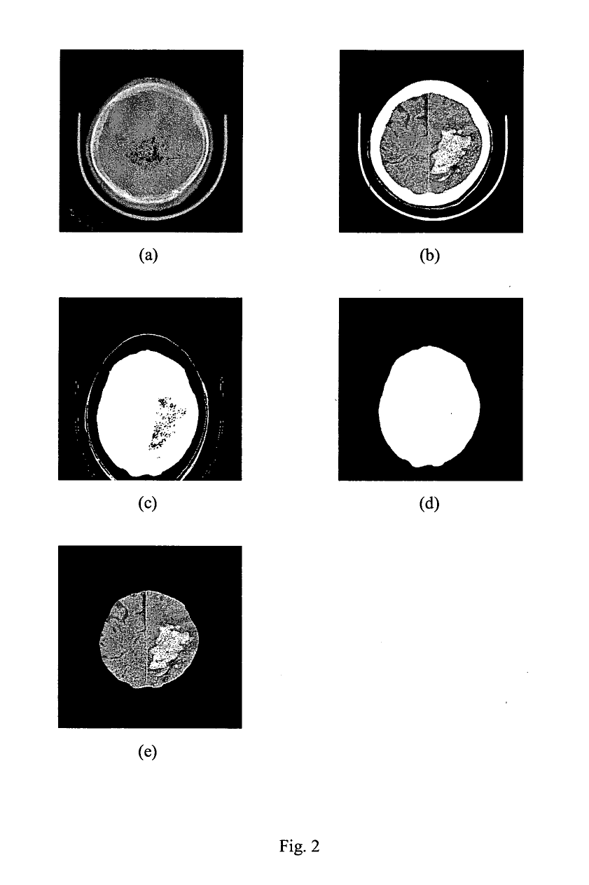

FIG. 2(a)-(e) illustrate an original CT scan image and the results of applying method 100 on the original CT scan image. FIG. 2(a) illustrates the original CT scan image in DICOM format. FIG. 2(b) illustrates the windowed intensity image obtained from the CT scan image in FIG. 2(a) after performing step 104. FIG. 2(c) illustrates the intermediate mask image after opening (step 106) is performed. FIG. 2(d) illustrates the final mask image obtained after the further morphological operations are performed in step 108. FIG. 2(e) illustrates the CT scan image with skull removed after performing the logical AND operation between the final mask image in FIG. 2(d) and the windowed intensity image in FIG. 2(b) (step 110).

### Method 300: Second Example of a Skull Removal Method for Slices not Near the Posterior Fossa

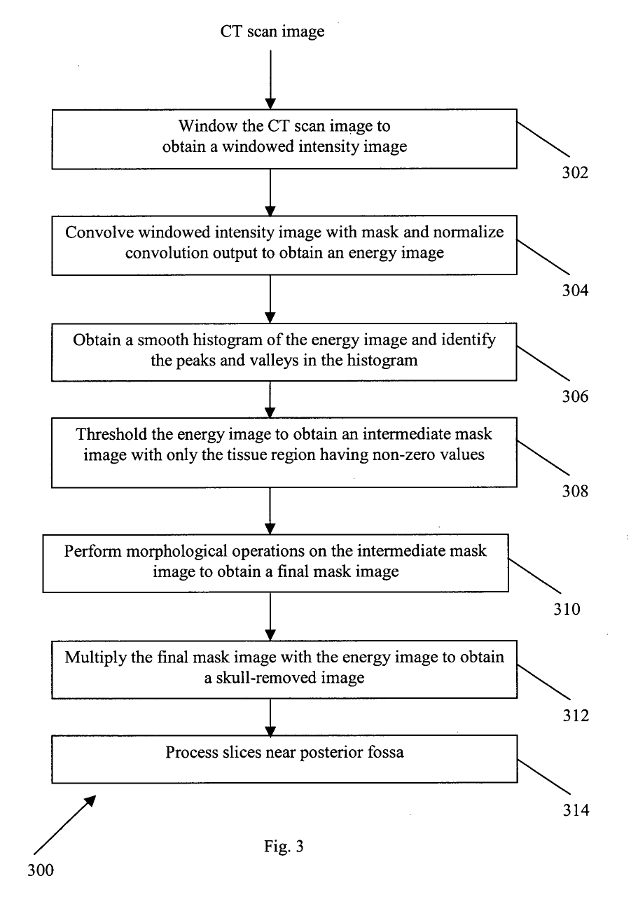

Referring to FIG. 3, the steps are illustrated of a method (method 300) which is a second embodiment of the method. The method 300 is an alternative method for removing portions of the CT scan data corresponding to the skull for slices of the CT scan volume.

The input to method 300 is a CT scan image. In one example, the CT scan image is in the DICOM format.

In step 302, the CT scan image is first windowed to obtain a windowed intensity image using window information (window width and window level) from the DICOM header. The window information is usually preset in the CT scanner and can be adjusted by radiologists.

In step 304, the windowed intensity image is convolved with a textural mask and normalized to obtain an “energy image”. Any textural mask which has the effect of a band pass filter can be used since the main aim of convolving the windowed intensity image with a mask is to remove unwanted frequencies and to map the filtered region so as to produce a histogram which can give a higher delineation between the peaks and/or valleys to facilitate thresholding.

In one example, the mask is a modified Laws' textural mask which is a 5×5 matrix denoted by Mod_S5E5^{T}, where the superscript T represents the transpose of the matrix S5E5, which is a 5×5 matrix obtained from the two vectors denoted S5 and E5 [5, 6]. The equations for the laws' textural mask S5E5 and the modified Laws' textural mask Mod_S5E5 are given below as Equations (2) and (3) respectively. In example embodiments, the modified Laws' textural mask in Equation (3) is not entirely symmetrical and hence, although the cut-off frequencies along the vertical and horizontal directions of the mask are similar, the bandwidths along the vertical and horizontal directions of the mask are different. Furthermore, the coefficients in the mask are changed in such a way that the mask averages the points in the image to remove some of the high frequencies (representing noise) and enhances edges and spots in the image.

$$\begin{matrix}S 5 E {5}^{T} = ( \begin{matrix}1 & 2 & 0 & - 2 & - 1 \\ 0 & 0 & 0 & 0 & 0 \\ - 2 & - 4 & 0 & 4 & 2 \\ 0 & 0 & 0 & 0 & 0 \\ 1 & 2 & 0 & - 2 & - 1\end{matrix} ) & ( 2 ) \\ Mod\_S 5 E {5}^{T} = ( \begin{matrix}1 & - 2 & 0 & - 2 & - 1 \\ 0 & 0 & 0 & 0 & 0 \\ 2 & - 4 & 0 & - 4 & - 2 \\ 0 & 0 & 0 & 0 & 0 \\ 1 & - 2 & 0 & - 2 & - 1\end{matrix} ) & ( 3 )\end{matrix}$$

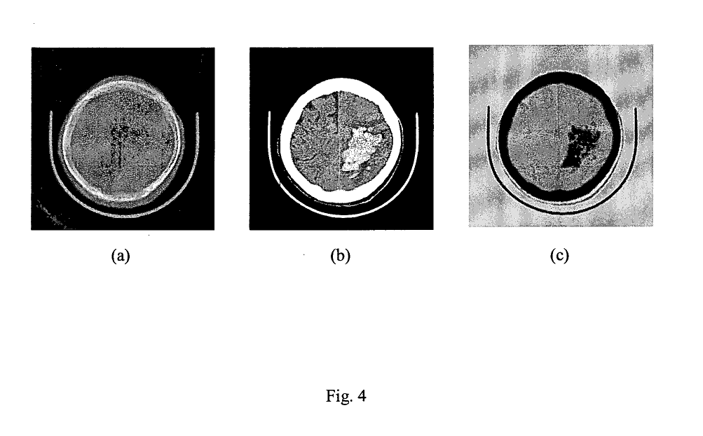

FIG. 4(a)-(c) illustrate an original CT scan image and the results of applying steps 302 and 304 of method 300 on the original CT scan image. FIG. 4(a) illustrates the original CT scan image in DICOM format whereas FIG. 4(b) illustrates the windowed intensity image after windowing (i.e. step 302) is performed on the DICOM image in FIG. 4(a). FIG. 4(c) illustrates the energy image obtained after convolving the windowed intensity image in FIG. 4(b) with the modified laws' mask Mod_S5E5^{T} shown in Equation (3) (i.e. step 304).

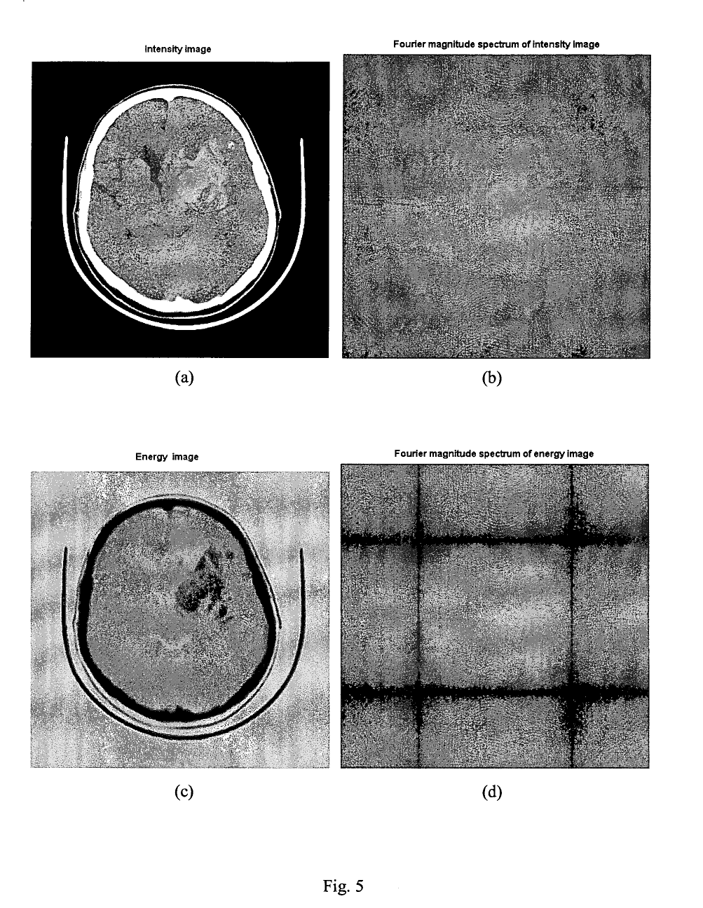

FIG. 5(a) illustrates a windowed DICOM intensity image obtained from step 302 and the energy image obtained from step 304 is shown in FIG. 5(c). Their respective Fourier magnitude spectrums are shown in FIG. 5(b) and FIG. 5(d). As shown in FIG. 5, the Fourier magnitude spectrums for both the windowed intensity image and the energy image are similar except that unwanted frequencies have been filtered away in FIG. 5(d). This non linear filtering operation can better delineate the peaks and/or valleys in the histogram and helps in identifying a suitable threshold for segmentation in subsequent steps.

In step 306 of FIG. 3, a smooth histogram of the values in the energy image is obtained by first calculating the histogram of the energy image and then filtering the calculated histogram to obtain a smooth histogram. In example embodiments, to obtain a smooth histogram, a zero-phase digital filtering is performed by processing the histogram data in both the forward and reverse directions. A first round of filtering is performed on the histogram data and the data sequence of the filtered data is then reversed. The reversed data is then filtered again to obtain the smooth histogram. The histogram obtained in this manner has precisely zero-phase distortion and has a magnitude that is the square of the filter's magnitude response.

Next in step 306, the peaks and valleys in the histogram are identified.

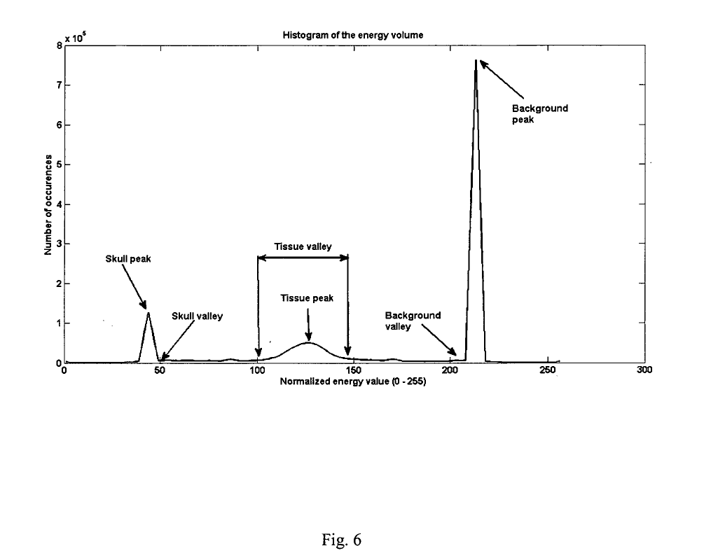

FIG. 6 illustrates one example of the smooth histogram obtained from step 306 in method 300. In FIG. 6, the peak with the highest normalized energy value (at the right hand side of the histogram) is the background peak, the peak with the lowest normalized energy value (at the left hand side of the histogram) is the skull peak whereas the peak with the normalized energy value in between the highest and the lowest normalized energy values is the tissue peak. The valley points (skull valley, background valley and tissue valley) are also shown in the histogram in FIG. 6.

In step 308, thresholding is performed on the energy image using the normalized energy values at the background valley and at the skull valley in the histogram as the thresholds to obtain an intermediate mask image with only the tissue region having non-zero values.

In step 310, morphological operations are performed on the mask image. Firstly, a morphological operation (opening) is performed on the mask image using a suitable structuring element to remove the unwanted connections between the skull and the brain tissue. Morphological operations of dilation and image filling are then performed to restore the tissue region inside the skull to obtain a final mask image.

In step 312, the final mask image is subsequently multiplied with the energy image to obtain an image with the skull removed (skull-removed image).

In example embodiments, method 300 is performed on each slice of the CT scan volume. Alternatively, method 300 can be performed directly on the CT scan volume.

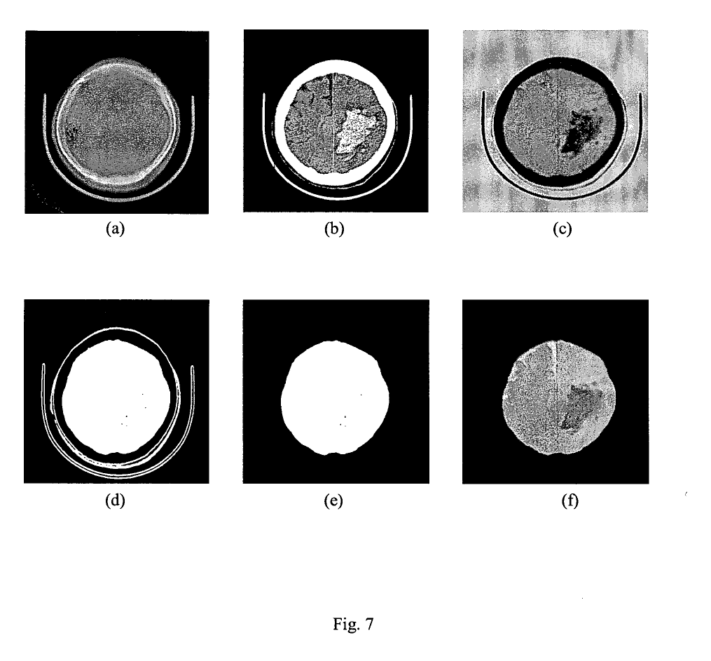

FIG. 7(a)-(f) illustrate an original CT scan image and the results of applying method 300 on the original CT scan image. FIG. 7(a) illustrates the original CT scan image in DICOM format. FIG. 7(b) illustrates the windowed intensity image obtained from the CT scan image in FIG. 7(a) after step 302 is performed. FIG. 7(c) illustrates the energy image obtained from the intensity image in FIG. 7(b) after step 304 is performed. FIG. 7(d) illustrates the initial mask after thresholding in step 308 is performed whereas FIG. 7(e) illustrates the final mask after performing the morphological operations in step 310. FIG. 7(f) illustrates the image with the skull removed after multiplying the final mask image with the energy image in step 312.

### Step 112 in Method 100 and Step 314 in Method 300

Referring to FIG. 8, the steps are illustrated of a process 800 which is step 112 in method 100 and step 314 in method 300. This process removes portions of the CT scan data corresponding to the skull for slices of the CT scan volume near the posterior fossa as earlier defined.

The process 800 employs the CT scan volume and tissue regions in slices of the CT scan volume not near the posterior fossa. In one example, the tissue regions are obtained using method 100 and an example of such a tissue region is shown in FIG. 2(d). Alternatively, the tissue regions can be obtained using method 300 and an example of such a tissue region is shown in FIG. 7(e).

In step 802, the area of the tissue region in each slice of the CT scan volume (except slices near the posterior fossa) is calculated. In step 804, the slice containing the maximum tissue area (i.e. maximum tissue area slice) is then located and the mask image for this maximum tissue area slice is denoted as the Reference Mask. In step 806, the differences in the tissue area between consecutive slices for slices extending from the maximum tissue area slice to the posterior fossa are calculated. In step 808, the process finds the pair of slices where the difference in tissue area between consecutive slices is larger than a predetermined threshold (for example 10%), and the slice further away from the maximum tissue area slice is selected. The slice further away from the maximum tissue area slice is referred to as the Reference slice.

In step 810, starting from (and including) the Reference slice, slices further away from the posterior fossa are processed in the same manner as those slices not near the posterior fossa. In other words, steps 102 to 110 of method 100 or steps 302 to 312 of method 300 are performed on each of these slices. For each of these slices, the largest connected component in the CT scan image obtained from steps 102 to 110 of method 100 or steps 302 to 312 of method 300 is selected to be the tissue region.

On the other hand, in step 812, for each of the slices nearer to the posterior fossa as compared to the Reference slice, points with values lower than a pre-determined lower limit are set to zero to form an intermediate mask image. In one example, the lower limit is the intensity value (if the points in the slices are in intensity values) or the Hounsfield value (if the points in the slices are in Hounsfield values) of the background. Note that windowing is performed on all the slices of the CT scan volume.

Subsequently, in step 814 morphological operations are performed on the intermediate mask image to remove unwanted connections between the skull and the brain tissue to obtain a final mask image. In one example, the morphological operations of opening, dilation and image filling are performed in step 814.

Lastly, in step 816, the final mask image is multiplied with the windowed intensity image or the energy image to obtain an image with the skull removed (i.e. a skull-removed image). This is equivalent to a logical AND operation between the final mask image and the windowed intensity image or the energy image. The windowed intensity image or the energy image of each slice in the CT scan volume near the posterior fossa can be obtained in the same way as described in step 104 or steps 302 and 304. For each of these slices nearer to the posterior fossa as compared to the Reference slice, all the regions in the skull-removed image are taken to be the tissue regions.

FIG. 9(a)-(e) illustrate the windowed intensity images of two slices of the CT scan volume near the posterior fossa and the results of applying method 800 on these slices. FIG. 9(a) illustrates a plot with curve 902 showing the tissue area of each slice in the CT scan volume (except slices near the posterior fossa) against the slice number. The plot in FIG. 9(a) can be used for step 804. In FIG. 9(a), the slice with the maximum tissue area is slice number 10. FIGS. 9(b) and (d) illustrate the windowed intensity images of two slices near the posterior fossa. FIGS. 9(c) and (e) correspond to FIGS. 9(b) and (d) respectively and illustrate the images (with skull removed) obtained after the logical AND operation of the final mask images and the windowed intensity images in FIGS. 9(c) and (e) in step 816 of method 800.

### Method 1000: First Example of a Method to Identify and Segment Hemorrhagic Slices in the CT Scan Volume

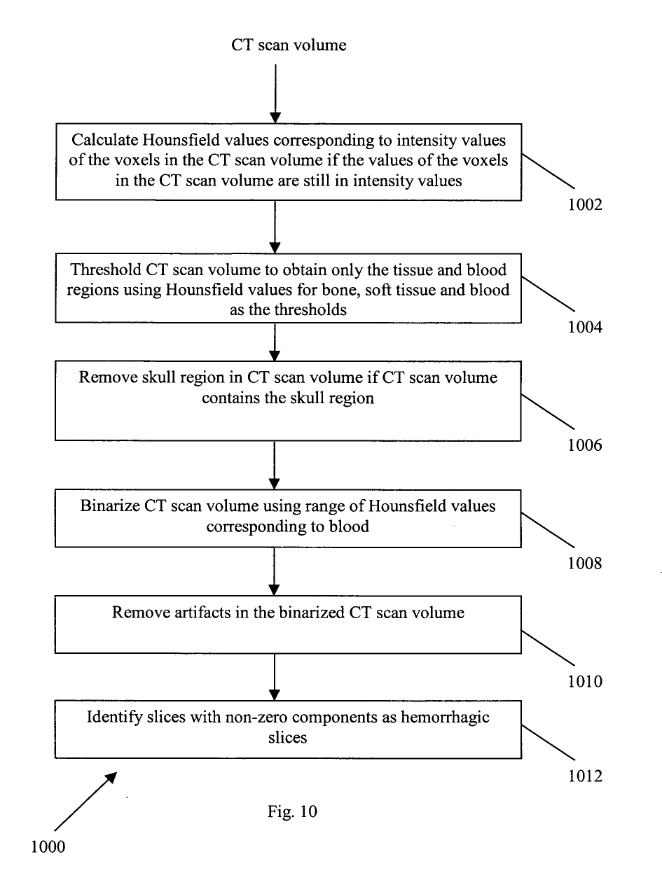

Referring to FIG. 10, the steps are illustrated of a further embodiment of the invention, which is a first example of a method (method 1000) which identifies and segments hemorrhagic slices in the CT scan volume.

The input to method 1000 is a CT scan volume. In one example, the CT scan volume is read from the DICOM file. Alternatively, the CT scan volume can be read from the RAW file. Furthermore, the CT scan volume can include or exclude the skull region.

In step 1002, if the values of the voxels in the CT scan volume are in intensity values, the Hounsfield values corresponding to these intensity values are calculated using the slope and intercept values obtained from the DICOM header. The calculation of the Hounsfield value is performed according to Equation (1) as shown above.

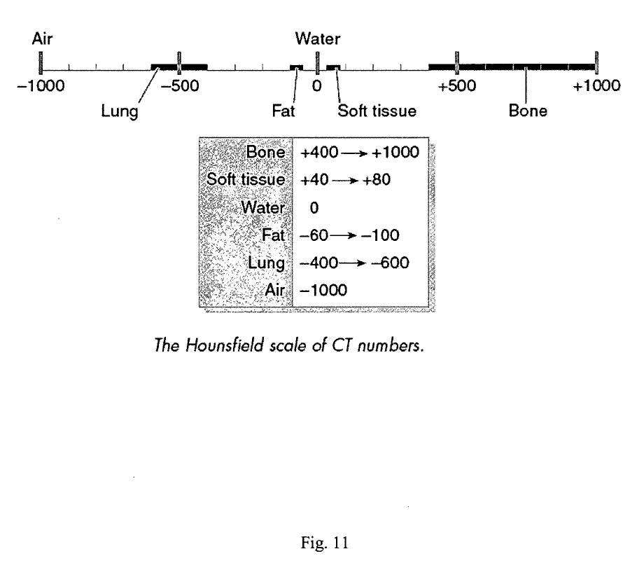

In step 1004, the CT scan volume is thresholded to obtain only the tissue and blood regions using the Hounsfield values for bone, soft tissue and blood as the thresholds. FIG. 11 and Table 1 (http://www.kevinboone.com/biodat hounsfld.html) show the Hounsfield scale of CT numbers for different tissue types, including the Hounsfield values for bone, soft tissue and blood. In general, the range of Hounsfield values of blood is 50-100. The range of Hounsfield values is usually 60-90 for hemorrhage regions and 50-90 for acute blood (blood 24 hours old or less). Also, the Hounsfield value for old blood is approximately 40. In example embodiments, the range of Hounsfield values for blood is taken to be 50-100.

TABLE 1

| Substance | Hounsfield Value |
|---|---|
| Bone | 80-1000 |
| Calcification | 80-10000 |
| Congealed Blood | 56-76 |
| Grey Matter | 36-46 |
| White Matter | 22-32 |
| Water | 0 |
| Fat | −100 |
| Air | −1000 |

In step 1006, if the CT scan volume contains the skull region, this skull region is removed. In one example, the skull region can be removed by a combination of methods 100 and 800. Alternatively, the skull region can be removed by a combination of methods 300 and 800 or any other method.

In step 1008, the resulting CT scan volume from step 1006 is then binarized using the range of Hounsfield values corresponding to blood (i.e. the blood window). This is performed by setting voxels with Hounsfield values outside the blood window to zero. In example embodiments, the blood window is 50-100. By binarizing the CT scan volume, segmentation of the hemorrhagic slices is achieved in step 1008.

In step 1010, artifacts in the binarized CT scan volume are removed. The steps to remove the artifacts are elaborated further below. Lastly, in step 1012, the slices with non-zero components are identified as the hemorrhagic slices.

### Method 1200: Second Example of a Method to Identify and Segment Hemorrhagic Slices in the CT Scan Volume

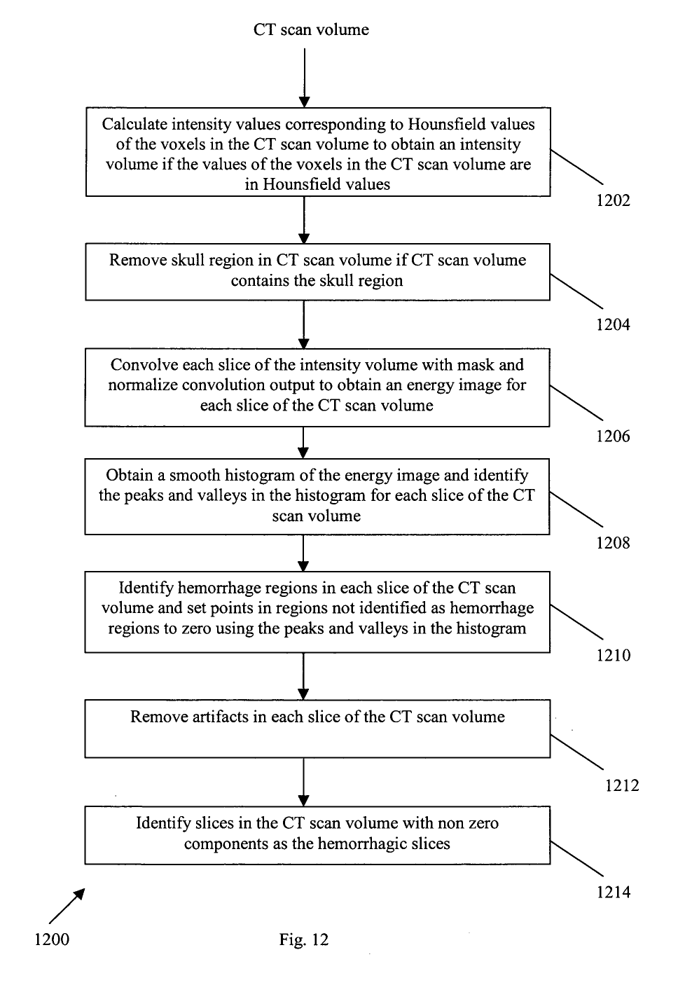

Referring to FIG. 12, the steps are illustrated of a further embodiment of the invention, which is a second example of a method (method 1200) which identifies and segments hemorrhagic slices in the CT scan volume.

The input to method 1200 is a CT scan volume. In one example, the CT scan volume is read from the DICOM file. Alternatively, the CT scan volume can be read from the RAW file. Furthermore, the CT scan volume can include or exclude the skull region.

In step 1202, if the values of the voxels in the CT scan volume are in Hounsfield values, the intensity values corresponding to these Hounsfield values are calculated to obtain an intensity volume using the slope and intercept values obtained from the DICOM header. The intensity values can be calculated using Equation (4).

Intensity value=(Hounsfield value−Intercept)/Slope (4)

In step 1204, if the CT scan volume contains the skull region, the skull region is removed. In one example, the skull region can be removed by a combination of methods 100 and 800. Alternatively, the skull region can be removed by a combination of methods 300 and 800 or any other method.

In step 1206, each slice in the intensity volume is convolved with the modified Laws' [5, 6] textural mask (Mod_S5E5^{T}) shown in Equation (3) and is then normalized to obtain an energy image for each slice in the CT scan volume.

In step 1208, a smooth histogram of the energy image for each slice in the CT scan volume is obtained by first calculating the histogram of the energy image and then performing filtering on the calculated histogram to obtain a smooth histogram in the same manner as described above in step 306. Next in step 1208, peaks and valleys in the smooth histogram obtained for each slice of the CT scan volume are identified.

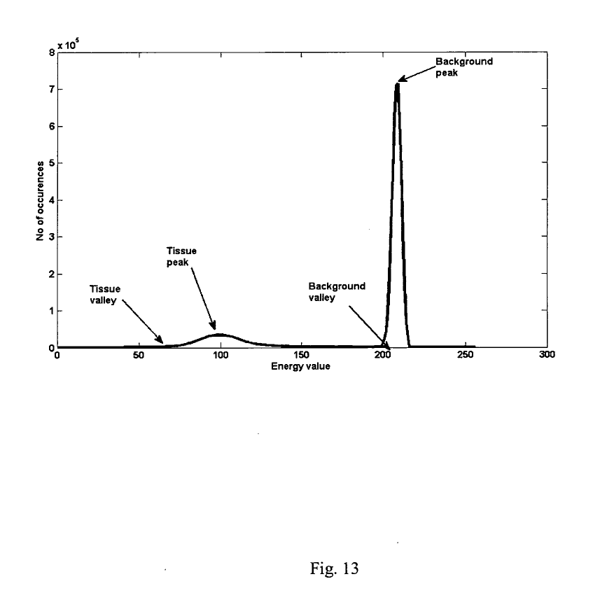

FIG. 13 illustrates one example of the smooth histogram obtained from step 1208 in method 1200. In FIG. 13, the peak with the higher energy value (at the right hand side of the histogram) is the background peak whereas the peak with the lower energy value (at the left hand side of the histogram) is the tissue peak. The tissue valley and background valley are also shown in FIG. 13.

In step 1210, hemorrhage regions are identified in each slice of the CT scan volume and points in the regions not identified as hemorrhage regions are set to zero. This results in the segmentation of the hemorrhage regions in the identified hemorrhagic slices.

If the energy value at the tissue valley is less than or equal to the energy value at the tissue peak multiplied by a parameter α the following steps are performed in step 1208. In one example, the value of α is 0.4 so that step 1210 can be used to detect both low and high amounts of hemorrhage. However, the value of α can be varied depending on whether slices with a low amount of hemorrhage or slices with a high amount of hemorrhage are to be detected. The amount of hemorrhage is defined as the percentage of hemorrhage area with respect to tissue area. A data vector of all values ranging between 0 to the energy value at the background valley is formed and is then clustered using a clustering method. The clustering method may be the kmeans method, Fuzzy C-means method, Neural network or thresholding. The points in the cluster with higher energy values correspond to the non-hemorrhage regions in each slice and the values in these regions are set to zero.

On the other hand, if the energy value at the tissue valley is greater than the energy value at the tissue peak multiplied by the parameter α, the following steps are performed in step 1208. The energy image is first thresholded using the energy value at the tissue valley as the threshold such that regions of the energy image with an energy value below the energy value of the tissue valley are identified as hemorrhage regions. The values of the regions in each slice not identified as the hemorrhage regions are then set to zero.

In step 1212, artifacts in each slice of the CT scan volume are removed. The steps to remove the artifacts are elaborated further below. Lastly, in step 1214, slices with non-zero components in the CT scan volume are identified as hemorrhagic slices.

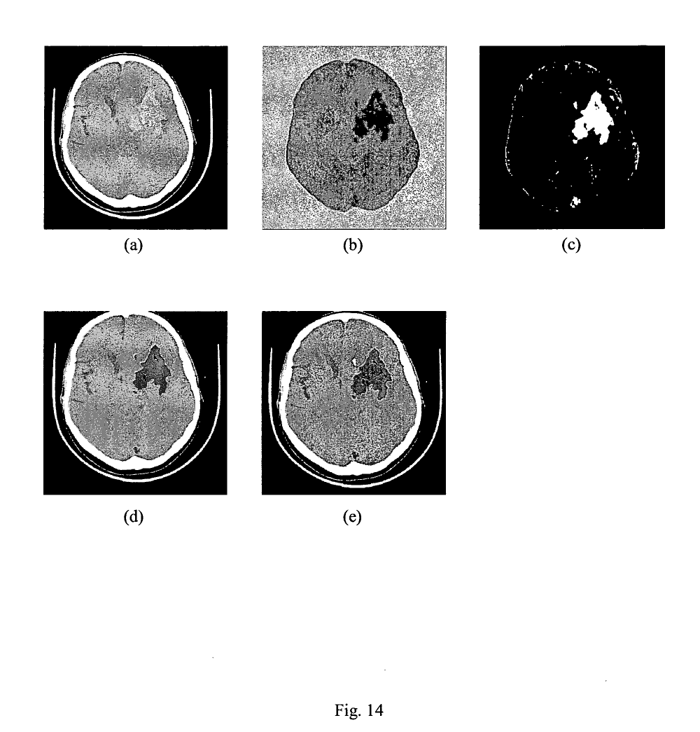

FIG. 14(a)-(e) illustrate an original CT scan image (a single slice of the CT scan volume) and the results of applying method 1200 on the original CT scan image. FIG. 14(a) shows the original CT scan image with hemorrhage regions whereas FIG. 14(b) shows the skull removed energy image obtained after steps 1202 to 1206 are performed on the image in FIG. 14(a). FIG. 14(c) shows the resulting image after steps 1208 to 1210 are performed on the image in FIG. 14(b). FIG. 14(d) illustrates the results after a first round of artifact removal is performed on the image in FIG. 14(c) and FIG. 14(e) shows the resulting image after a second round of artifact removal is performed on the image in FIG. 14(d).

### Method 1500: An Example of a Method to Segment Hemorrhage Regions in the CT Scan Volume

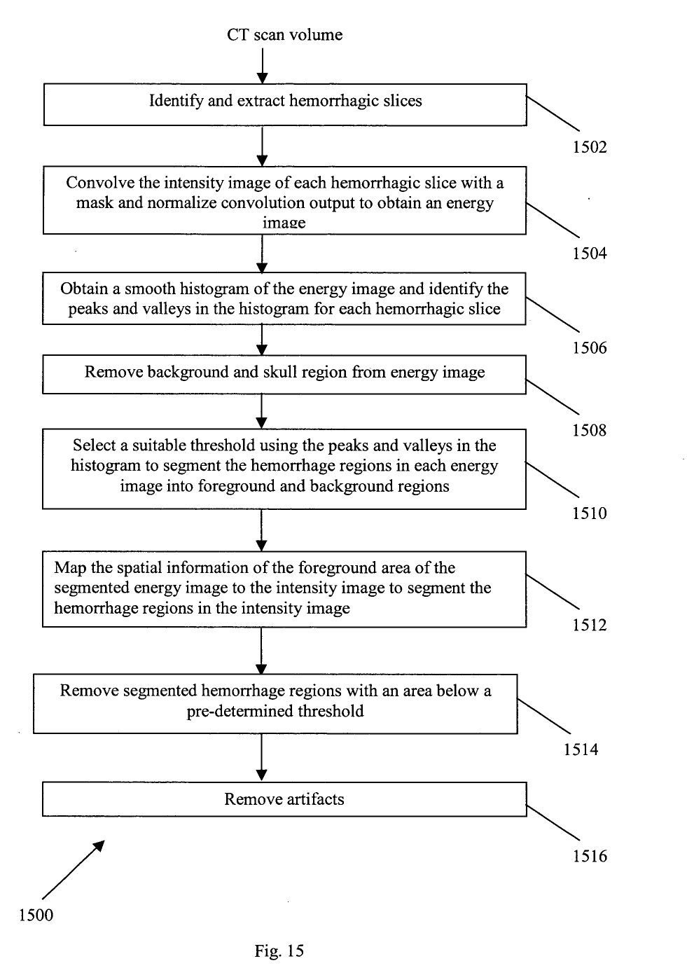

Referring to FIG. 15, the steps are illustrated of a further embodiment of the invention, which is an example of a method (method 1500) which segments hemorrhagic slices in the CT scan volume.

The input to method 1500 is a CT scan volume. In one example, the CT scan volume is read from the DICOM file. Alternatively, the CT scan volume can be read from the RAW file. Furthermore, the CT scan volume can include or exclude the skull region.

In step 1502, hemorrhagic slices are identified and extracted. In one example, the hemorrhagic slices are identified using method 1000. Alternatively, the hemorrhagic slices can be identified using method 1200 or any other method.

In step 1504, the intensity image of each hemorrhagic slice is convolved with the modified Laws' [5, 6] textural mask (Mod_S5E5^{T}) shown in Equation (3) and is normalized to obtain an energy image for each hemorrhagic slice. In one example, the intensity image of each hemorrhagic slice is windowed to obtain a windowed intensity image using the window information (window width and window level from the DICOM header) prior to the convolution process.

In step 1506, a smooth histogram for the energy image corresponding to each hemorrhagic slice is obtained by first calculating the histogram for each energy image and subsequently filtering the calculated histogram. Next, in step 1506, the peaks and valleys of the histogram are identified. If the skull region is present in the CT scan volume, the histogram as obtained is shown in FIG. 6. Otherwise, the histogram as obtained is shown in FIG. 13.

Steps 1502 and 1504 can be omitted if method 1200 is used to identify the hemorrhagic slices since in method 1200, the energy image and the histogram of the energy image are already obtained for each identified hemorrhagic slice.

In step 1508, the background region and the skull region are removed from the energy image by thresholding the energy image using the energy values at the background, tissue or skull peaks and/or valleys as the thresholds. This is done by retaining the points in the energy image with energy values between the background valley and the skull valley (if skull region is present in the CT scan volume) or between the background valley and the tissue valley with a lower energy value (if skull region is not present in the CT scan volume)

In step 1512, a suitable threshold is selected to segment the hemorrhage regions in each hemorrhagic slice into foreground and background areas. The tissue peak (T_{P}) is found and starting at T_{P}, the tissue valley point T_{V} towards the lower energy value is found.

If T_{V}≦(S_{V}+0.5*(T_{P}−S_{V})) where Sᵥ represents the skull valley, a clustering method, which can be the k-means method, Fuzzy C-means method, Gaussian mixture modelling method or a thresholding method which can be the Otsu method is used to find a threshold for the data between the S_{V} and the background valley. The energy image is then segmented into foreground and background areas using this threshold. In example embodiments, if the CT scan volume does not include the skull region, Sᵥ is set as zero. This is because, in general, the Hounsfield value or intensity value of the bone is higher than that of the blood in the energy image. Therefore, the skull region will appear darker than the blood regions and T_{V} is compared against (S_{V}+0.5*(T_{P}−S_{V})) to determine how the regions in the energy image are to be divided into foreground and background regions. If the skull region in the CT scan volume is removed, then the darker regions are most likely blood regions and T_{V} can be simply compared against (0.5*(T_{P})). In other words, Sᵥ can be set as zero.

On the other hand, if T_{V}>(S_{V}+0.5*(T_{P}−S_{V})), the regions in the energy image with energy values between S_{V} and T_{V} are grouped as the foreground area whereas the remaining regions are grouped as the background area.

In step 1512, the spatial information of the foreground area of the segmented energy image is mapped to the intensity image (which may be windowed) to segment the hemorrhage regions in each hemorrhagic slice.

In step 1514, a threshold defining the minimum size of a hemorrhage region is determined and segmented hemorrhage regions with an area below this threshold are removed.

In step 1516, artifacts are removed. The steps to remove the artifacts are elaborated further below.

If there is a “ground truth” (e.g. a correct segmented image obtained from a human expert), then a comparison may be done at this point to verify the reliability of the method above.

In example embodiments, steps 1504-1516 are performed on each hemorrhagic slice. Alternatively, steps 1504-1516 can be performed on the CT scan volume directly.

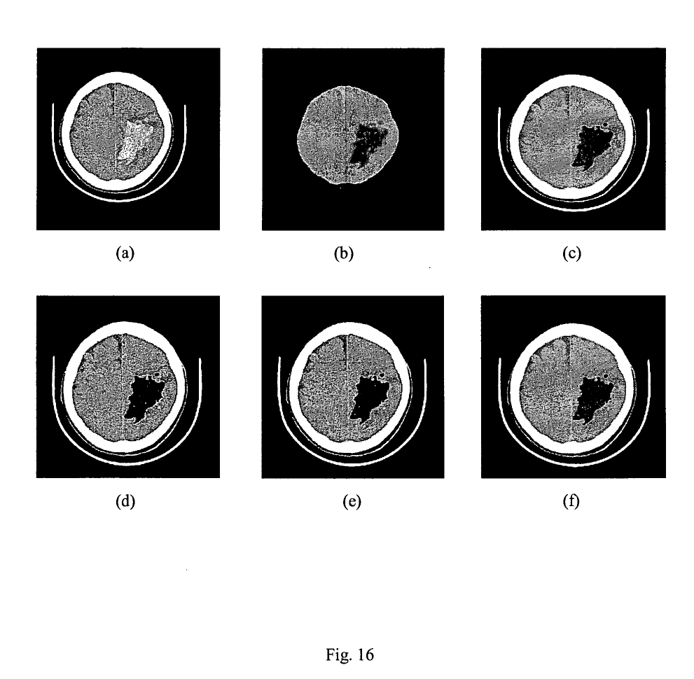

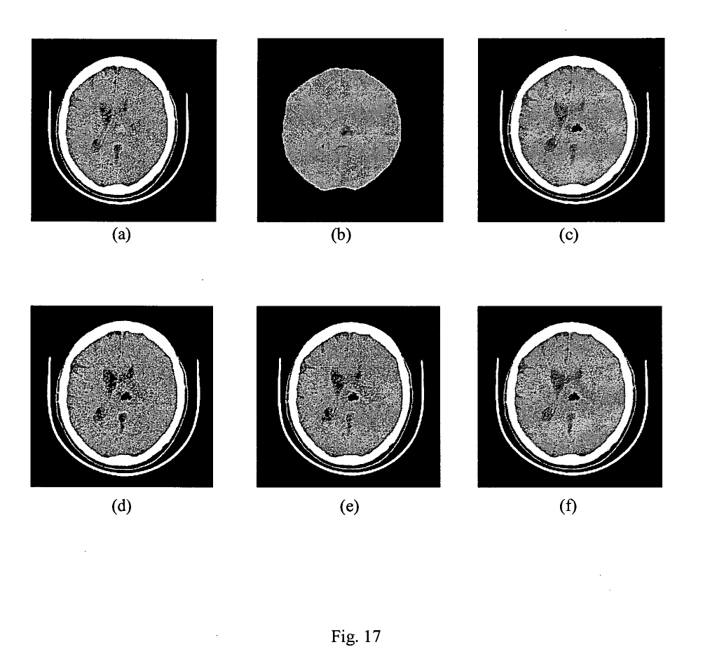

FIGS. 16 and 17 illustrate the results of applying method 1500 on two different hemorrhagic slices of a CT scan volume. FIGS. 16(a) and 17(a) illustrate the intensity images of the hemorrhagic slices whereas FIGS. 16(b) and 17(b) illustrate the corresponding energy images. FIGS. 16(c)-(f) illustrate the segmented intensity image for the first slice using Gaussian mixture model, Fuzzy C-means, K-means and Otsu method respectively whereas FIGS. 17(c)-(f) illustrate the segmented intensity image for the second slice using Gaussian mixture model, Fuzzy C-means, K-means and Otsu method respectively.

Removal of Artifacts in Steps 1010, 1212 and 1514

Some examples of the artifacts which may be present in CT scan images and which may affect the skull removal, slice identification and segmentation processes (for example methods 100, 300, 800, 1000, 1200 and 1500) are falx celebri (which may appear as part of a hemorrhage region), partial volume effects and beam hardening effects. Falx celebri is usually close to the mid sagittal plane and appears generally in the inter hemispheric fissure of the axial slices.

In example embodiments, falx celebri is removed using shape analysis whereas beam hardening and partial volume artifacts are eliminated using the statistical analysis, shape analysis and morphological operations.

In example embodiments, shape analysis is done by calculating the Eigen values. Alternatively, shape analysis can be done by tracing the boundaries of the tissue or hemorrhage regions or by any other method. In example embodiments, statistical analysis is done by extracting various first order statistics and by performing classification. Image features are also used to differentiate between the artifacts and the hemorrhage regions in example embodiments so as to remove the artifacts.

Method 1800: An example of a Method for the Segmentation of the Catheter Region

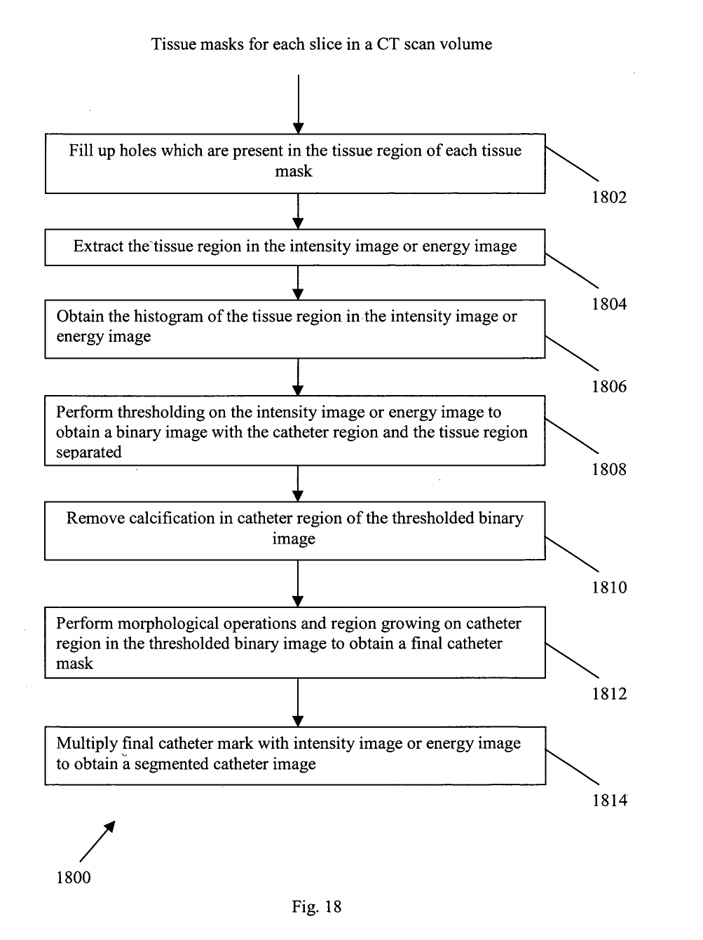

Referring to FIG. 18, the steps are illustrated of an example of a method (method 1800) which segments the catheter region. This method can be employed to improve the methods above which are embodiments of the present invention.

The inputs to method 1800 are mask images used for extracting the tissue region (i.e. tissue masks) for each slice in a CT scan volume. In one example, the tissue masks are obtained using the combination of methods 100 and 800. Alternatively, the tissue masks can be obtained using the combination of methods 300 and 800 or any other method.

In step 1802, holes which are present in the tissue region of each tissue mask are filled and in step 1804, the tissue region in the intensity image is obtained by performing a logical AND operation between the tissue mask and the intensity image for each slice of the CT scan volume.

In step 1806, the histogram of the tissue region in the intensity image or the energy image is then obtained. If the energy data of the CT scan volume is not already available, it can be obtained in the same manner as described above, for example in steps 302 and 304 of method 300.

In step 1808, thresholding is performed on the intensity image or the energy image to obtain a binary image with the catheter region and the tissue region separated, the catheter region being the foreground and the tissue region being the background.

In step 1810, any calcification present in the foreground region is removed using shape analysis.

In step 1812, morphological operations and region growing are performed on the foreground region (i.e. catheter region) to obtain the final catheter mask.

Lastly, in step 1814, the final catheter mask is used for the segmentation of catheter by multiplying the final catheter mask with the intensity image or the energy image.

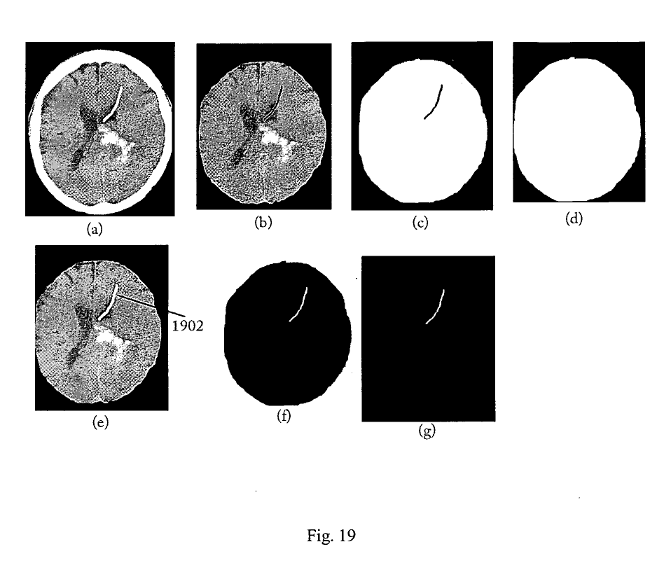

FIG. 19(a)-(g) illustrate an original CT scan image and the results of applying method 1800 on the original CT scan image. FIG. 19(a) shows the original CT scan image whereas FIG. 19(b) shows the skull stripped energy image. FIG. 19(c) shows the mask image obtained from the energy image. The images in FIGS. 19(a)-(c) can be obtained using a combination of methods 300 and 800 or any other method. FIG. 19(d) shows the mask image after the holes have been filled in step 1802. FIG. 19(e) shows the skull-removed tissue image with the catheter region 1902 after step 1804. FIG. 19(f) shows the final mask image to segment the catheter. The final mask image in FIG. 19(f) is obtained by performing steps 1806 to 1812 on the image in FIG. 19(e). FIG. 19(g) shows the segmented catheter region obtained after step 1814.

Experimental Results

22 CT scan volumes of hemorrhagic stroke patients were obtained. In these 22 CT scan volumes, 93 slices contained hemorrhage regions. In the experiment, in-plane resolution of the CT scans was set to either 0.45 mm×0.45 mm or 0.47 mm×0.47 mm, the matrix size of the CT scans was set to 512×512 and the thicknesses of each slice of the CT scans was set to 4.5 mm, 5 mm, 6 mm or 7 mm. The number of slices in the CT scans ranged from 17 to 33.

The sensitivity and specificity of the skull removal algorithms (a combination of method 100 and 800 and a combination of methods 300 and 800) in the example embodiments were found to be approximately 98% and 70% respectively. The slight inaccuracy was probably due to the presence of some dura matter and the eyeball regions in the skull. Furthermore, the average sensitivity and specificity for the hemorrhagic slice identification algorithms (method 1000 and method 1200) in the example embodiments were found to be approximately 96% and 74% respectively whereas the sensitivity and specificity of the hemorrhage segmentation algorithms (method 1000 and method 1500) in the example embodiments were found to be approximately 94% and 98% respectively. Furthermore, the dice statistical index (DSI) of the hemorrhage segmentation algorithms in the example embodiments is found to be about 80%. In addition, the entire process of removing skull regions, identifying and segmenting hemorrhagic slices using the example embodiments was found to take about 1 minute in the Matlab computing environment.

The methods in the example embodiments have the advantage that it reduces the amount of time needed to localize and segment the hemorrhagic regions as compared to prior art methods. In one example, the amount of time was found to be 1 minute in the Matlab computing environment. In fact, the speed of localization and segmentation can be increased further by implementing the method in the VC++ computing environment.

Some of the embodiments convert the intensity values to Hounsfield values before performing thresholding or morphological operations. This is advantageous as storing pixels in terms of their Hounsfield values occupy less memory since the range of Hounsfield values is shorter. Furthermore, the conversion from intensity values to Hounsfield values and vice versa can be achieved easily as long as the slope and intercept values are known from the DICOM header.

Furthermore, some of the embodiments use the histogram of the energy image rather than the histogram of the intensity image.

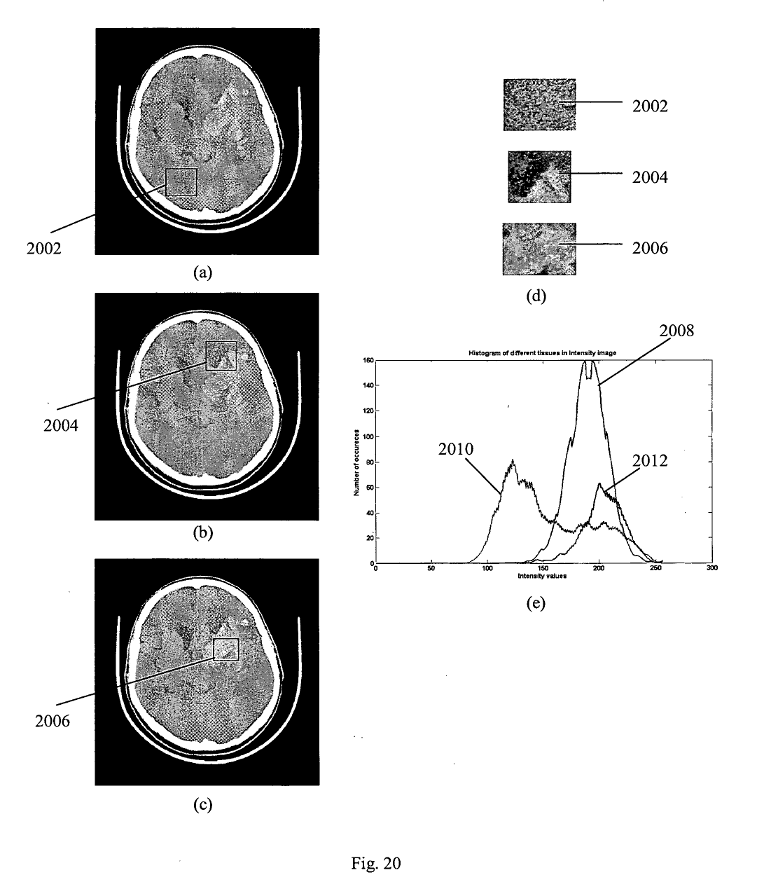

FIG. 20(a)-(e) illustrate the intensity image of a slice of a CT scan volume and the histogram of the intensity image. In FIG. 20(a)-(c), the intensity image is shown with different regions of interest (ROIs) selected. In FIG. 20(a), a normal tissue region 2002 is selected, in FIG. 20(b), a region 2004 containing both normal tissue and hemorrhagic tissue is selected and in FIG. 20(c), a haemorrhage region 2006 is selected. FIG. 20(d) shows the selected ROIs 2002, 2004 and 2006 whereas FIG. 20(e) shows the histogram of the intensity image with curves 2008, 2010 and 2012 corresponding to ROIs 2002 (normal tissue region), 2004 (region with both normal tissue and hemorrhagic tissue) and 2006 (hemorrhage region) respectively.

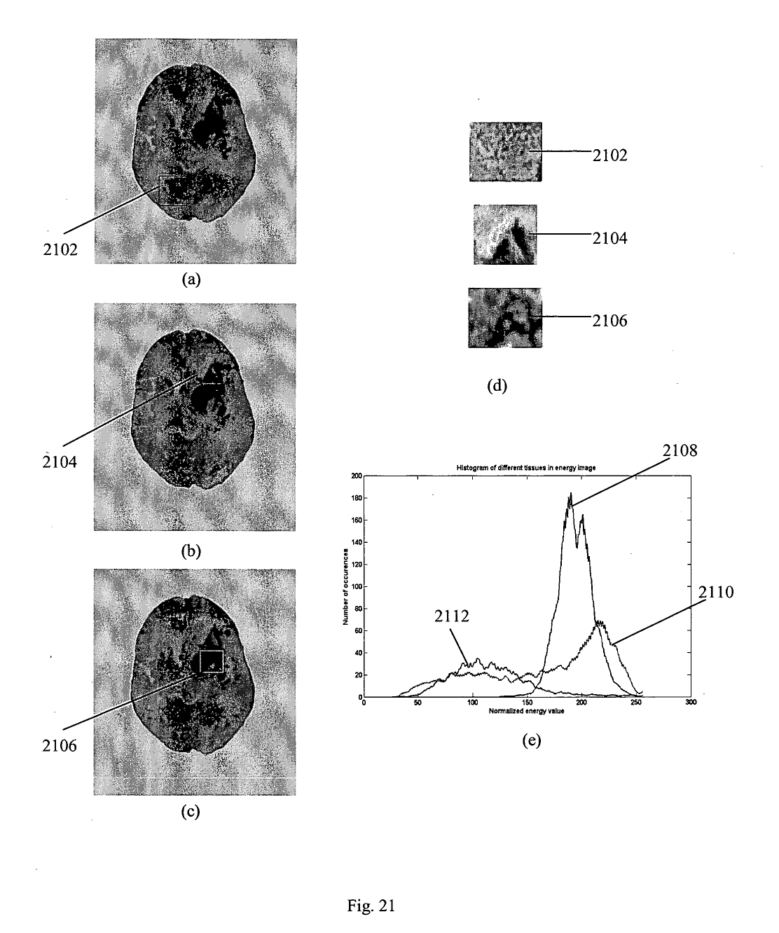

FIG. 21(a)-(e) illustrate the energy image of a slice of a CT scan volume and the histogram of the energy image. In FIG. 21(a)-(c), the intensity image is shown with different regions of interest (ROIs) selected. In FIG. 21(a), a normal tissue region 2102 is selected, in FIG. 21(b), a region 2104 containing both normal tissue and hemorrhagic tissue is selected and in FIG. 21(c), a haemorrhage region 2106 is selected. FIG. 21(d) shows the selected ROIs 2102, 2104 and 2106 whereas FIG. 21(e) shows the histogram of the intensity image with curves 2108, 2110 and 2112 corresponding to ROIs 2102 (normal tissue region), 2104 (region with both normal tissue and hemorrhagic tissue) and 2106 (hemorrhage region) respectively.

As shown in FIGS. 20(e) and 21(e), the two peaks corresponding to the normal tissue region and the hemorrhage region are well separated in the histogram of the energy image whereas they are overlapping in the histogram of the intensity image. This implies that there is a better delineation between the hemorrhage regions and the normal tissue regions in the histogram of the energy image as compared to the histogram of the intensity image. Furthermore, the histogram of the energy image shows a smooth and symmetric nature for normal tissues even in noisy slices of the CT scan volume. Therefore, by using the histogram of the energy image instead of the histogram of the intensity image, a more accurate detection of the hemorrhage regions in unenhanced CT images can be achieved.

The embodiments of the invention also have the advantage that they can be used for the identification and segmentation of hemorrhage regions for many different forms of hemorrhage such as Intra-cerebellar hemorrhage (ICH), intra-ventricular hemorrhage (IVH) or Sub-arachnoid hemorrhage (SAH).

### REFERENCES

[1] Graeb D A, Robertson W D, Lapointe S J, Nugent R A, Harrison P B. “Computed Tomographic Diagnosis of Intraventricular Hemorrhage”, Radiology 143:91-96, April, 1982.
[2] Vereecken K K, Havenbergh T V, Beuckelaar W D, Parizel P M, Jorens P G, “Treatment of Intraventricular hemorrhage with Intraventricular administration of recombinant tissue plasminogen activator A clinical study of 18 cases” Clinical Neurology and Neurosurgery, Volume 108, Issue 5, July 2006, Pages 451-455.
[3] Zimmerman R D, Maldjian J A, Brun N C, Horvath B, Skolnick B E. “Radiologic estimation of hematoma volume in Intracerebral hemorrhage trial by CT scan”. AJNR 27, March 2006, 666-670.
[4] Trouillas P, Kummer R von. “Classification and Pathogenesis of Cerebral Hemorrhages after Thrombolysis in Ischemic Stroke”. Stroke, 2006, 37,556.
[5] K. Laws. Textured Image Segmentation, Ph.D. Dissertation, University of Southern California, January 1980.
[6] K. Laws. Rapid texture identification. In SPIE Vol. 238 Image Processing for Missile Guidance, pages 376-380, 1980.

1.-31. (canceled)

32. A method of identifying hemorrhagic slices in CT scan data comprising intensity values at a set of respective CT scan points, the method comprising the steps of:
(a) convolving the CT scan data with a texture mask matrix representing a band pass filter in the spatial frequency domain, to obtain transformed data values;
(b) generating a histogram of the transformed data values;
(c) identifying at least one peak and/or at least one valley in the histogram; and
(d) thresholding the transformed data values based on the transformed data values at the identified peaks and valleys to identify the hemorrhagic slices in the CT scan data.

33. A method according to claim 32, wherein the step (b) comprises the sub-steps of:
(i) calculating a preliminary histogram of the transformed data values; and
(ii) filtering the preliminary histogram to generate the histogram of the transformed data values.

34. A method according to claim 32, further comprising the step of windowing the CT scan data, prior to step (a), using window information from a DICOM header of the CT scan data.

35. A method according to claim 32 in which step (c) comprises identifying a skull valley and a background valley, and the method further comprises a step of removing skull region from the transformed data values prior to step (d), wherein the step of removing the skull region from the transformed data values comprises the sub-steps of:
(i) obtaining a mask having non-zero values at points for which the transformed data values are between the skull valley and the background valley; and
(ii) using the mask to remove the skull region from the transformed data values.

36. A method according to claim 35, further comprising the step of performing morphological operations on the mask prior to the sub-step (ii).

37. A method according to claim 36, wherein the morphological operations comprise one or more of a group of an opening operation, a dilation operation and an image filling operation.

38. A method according to claim 32, wherein step (d) comprises the sub-steps of
(a) setting to zero the transformed data values not within determined ranges; and
(b) identifying haemorrhagic slices of the CT scan data as those slices with non-zero transformed data values.

39. A method according to claim 38, wherein the step (a) of claim 38 comprises the sub-steps of:
(i) determining if a transformed data value at a tissue valley in the generated histogram is less than a parameter α times the transformed data value at a corresponding tissue peak; and if so:
(ii) clustering the transformed data values ranging between zero and a transformed data value at a background valley; and
(iii) setting to zero the transformed data values in the cluster with higher transformed data values.

40. A method according to claim 39, comprising, if the determination is negative, if the transformed data value at the tissue valley in the generated histogram is negative:
(i) thresholding the transformed data values with the transformed data value at the tissue valley of the histogram;
(ii) setting to zero the transformed data values lower than the transformed data value at the tissue valley.

41. A method of segmenting hemorrhage regions in CT scan data, the method comprising the steps of:
(i) identifying hemorrhagic slices in the CT scan data by a method according to claim 32;
(ii) segmenting the transformed data values into foreground and background areas; and
(iii) mapping spatial information of the foreground area of the segmented transformed data values to the CT scan data to segment the hemorrhage regions in the CT scan data.

42. A method according to claim 41, wherein the step (ii) comprises the sub-step of thresholding or clustering the transformed data values to segment the transformed data values into foreground and background areas if T_{V}<(S_{V}+0.5*(T_{P}−S_{V})) wherein T_{V} is a transformed data value of a tissue valley, Tₚ is a transformed data value of a tissue peak and S_{V} is a transformed data value of a skull valley.

43. A method according to claim 41 wherein the step (ii) comprises the sub-step of grouping points in the transformed data values with transformed data values between S_{V} and T_{V} as the foreground area and remaining points as the background area if T_{V}>(S_{V}+0.5*(T_{P}−S_{V})) wherein T_{V} is a transformed data value of a tissue valley, Tₚ is a transformed data value of a tissue peak and S_{V} is a transformed data value of a skull valley.

44. A method of segmenting hemorrhage regions in CT scan data, the method comprising the steps of:
(i) identifying hemorrhagic slices in the CT scan data, convolving the CT scan data values in the identified hemorrhagic slices with a texture mask matrix representing a band pass filter in the spatial frequency domain to obtain transformed data values, generating a histogram of the transformed data values and identifying at least one peak and/or at least one valley in the histogram;
(ii) segmenting the transformed data values into foreground and background areas based on the transformed data values at the identified peaks and valleys; and
(iii) mapping spatial information of the foreground area of the segmented transformed data values to the CT scan data to segment the hemorrhage regions in the CT scan data;
wherein the hemorrhagic slices in the CT scan data are identified by a method comprising the steps of:
(a) transforming the CT scan data according to the Hounsfield scale into Hounsfield data;
(b) thresholding the Hounsfield data values using thresholds which are predefined Hounsfield scale values to remove skull region from the Hounsfield data values to obtain skull-removed Hounsfield data values; and
(c) identifying the hemorrhagic slices in the CT scan data using the skull-removed Hounsfield data values.

45. A method according to claim 44, wherein the step (ii) comprises the sub-step of thresholding or clustering the transformed data values to segment the transformed data values into foreground and background areas if T_{V}<(S_{V}+0.5*(T_{P}−S_{V})) wherein T_{V} is a transformed data value of a tissue valley, Tₚ is a transformed data value of a tissue peak and S_{V} is a transformed data value of a skull valley.

46. A method according to claim 44 wherein the step (ii) comprises the sub-step of grouping points in the transformed data values with transformed data values between S_{V} and T_{V} as the foreground area and remaining points as the background area if T_{V}>(S_{V}+0.5*(T_{P}−S_{V})) wherein T_{V} is a transformed data value of a tissue valley, Tₚ is a transformed data value of a tissue peak and S_{V} is a transformed data value of a skull valley.

47. A method of segmenting CT scan data to remove skull region, wherein the CT scan data comprises CT scan slices near a posterior fossa and CT scan slices not near the posterior fossa and the method comprises the steps of:
(i) segmenting the CT scan data to remove the skull region for the CT scan slices not near the posterior fossa; and
(ii) using the segmented CT scan data for the CT scan slices not near the posterior fossa to segment the CT scan slices near the posterior fossa;
wherein step (i) further comprises the sub-steps of:
(i-i) convolving the CT scan data with a texture mask matrix representing a band pass filter in the spatial frequency domain, to obtain transformed data values;
(i-ii) generating a histogram of the transformed data values;
(i-iii) identifying a skull valley and a background valley in the histogram;
(i-iv) obtaining a mask having non-zero values at points for which the transformed data values are between the skull valley and the background valley; and
(i-v) using the mask to remove the skull region from the transformed data values to segment the CT scan data.

48. A method of segmenting CT scan data to remove skull region, wherein the CT scan data comprises CT scan slices near a posterior fossa and CT scan slices not near the posterior fossa and the method comprises the steps of:
(i) segmenting the CT scan data to remove the skull region for the CT scan slices not near the posterior fossa; and
(ii) using the segmented CT scan data for the CT scan slices not near the posterior fossa to segment the CT scan slices near the posterior fossa;
wherein step (i) further comprises the sub-steps of:
(i-i) transforming the CT scan data according to the Hounsfield scale into Hounsfield data;
(i-ii) thresholding the Hounsfield data values using a lower limit of 90 HU and an upper limit of 400 HU to obtain a mask; and
(i-iii) removing the skull region from the Hounsfield data values by multiplying the mask with the Hounsfield data values.

49. A method according to claim 47, wherein the step (ii) comprises the sub-steps of:
(iii) locating the CT scan slice not near the posterior fossa and with a maximum tissue area, the CT scan slice not near the posterior fossa and with a maximum tissue area being a maximum tissue area slice;
(iv) calculating differences in tissue areas between consecutive slices for slices extending from the posterior fossa to the maximum tissue area slice;
(v) locating a pair of consecutive slices with the difference in tissue areas being larger than a predetermined threshold, the pair of consecutive slices comprising a first slice further away from the maximum tissue area slice and a second slice nearer the maximum tissue area slice, the first slice being a Reference slice;
(vi) segmenting the Reference slice and the CT scan slices lying further away from the posterior fossa than the Reference slice by a method comprising the sub-steps (i-i)-(i-v) to produce initial segmented CT scan slices;
(vii) segmenting a largest connected component in each of the initial segmented CT scan slices to produce final segmented CT scan slices for the Reference slice and the CT scan slices lying further away from the posterior fossa than the Reference slice;
(viii) removing points with values lower than a pre-determined lower limit in CT scan slices lying nearer the posterior fossa than the Reference slice to form a mask image for each slice; and
(ix) multiplying the mask images with the CT scan slices lying nearer the posterior fossa than the Reference slice to segment the CT scan slices lying nearer the posterior fossa than the Reference slice.

50. A method according to claim 48, wherein the step (ii) comprises the sub-steps of:
(iii) locating the CT scan slice not near the posterior fossa and with a maximum tissue area, the CT scan slice not near the posterior fossa and with a maximum tissue area being a maximum tissue area slice;
(iv) calculating differences in tissue areas between consecutive slices for slices extending from the posterior fossa to the maximum tissue area slice;
(v) locating a pair of consecutive slices with the difference in tissue areas being larger than a predetermined threshold, the pair of consecutive slices comprising a first slice further away from the maximum tissue area slice and a second slice nearer the maximum tissue area slice, the first slice being a Reference slice;
(vi) segmenting the Reference slice and the CT scan slices lying further away from the posterior fossa than the Reference slice by a method comprising the sub-steps (i-i)-(i-iii) to produce initial segmented CT scan slices;
(vii) segmenting a largest connected component in each of the initial segmented CT scan slices to produce final segmented CT scan slices for the Reference slice and the CT scan slices lying further away from the posterior fossa than the Reference slice;
(viii) removing points with values lower than a pre-determined lower limit in CT scan slices lying nearer the posterior fossa than the Reference slice to form a mask image for each slice; and
(ix) multiplying the mask images with the CT scan slices lying nearer the posterior fossa than the Reference slice to segment the CT scan slices lying nearer the posterior fossa than the Reference slice.

51. A method according to claim 49, wherein the pre-determined lower limit is an intensity value or a Hounsfield value of the background of the corresponding CT scan slice.

52. A method according to claim 49, further comprising the step of performing morphological operations on the mask images prior to the step of multiplying the mask images with the CT scan slices lying nearer the posterior fossa than the Reference slice.

53. A method according to claim 52, wherein the morphological operations comprise one or more of a group of an opening operation, a dilation operation and a tissue filling operation.

54. A method according to claim 32, further comprising a step of segmenting a catheter region in the CT scan data.

55. A method according to claim 54, wherein the step of segmenting the catheter region from the CT scan data comprises the sub-steps of:
(i) generating a histogram for a tissue region of the CT scan data;
(ii) thresholding the CT scan data into foreground and background areas using the histogram values to generate a mask with values in the background area set to zero; and
(iii) multiplying the mask with the CT scan data to segment the catheter region in the CT scan image.

56. A method according to claim 55, further comprising the step of performing morphological operations on the foreground area of the mask prior to the step of multiplying the mask with the CT scan data.

57. A method according to claim 32, further comprising an artifact reduction step.

58. A computer system having a processor arranged to perform a method according to claim 32.

59. A computer system having a processor arranged to perform a method according to claim 44.

60. A computer system having a processor arranged to perform a method according to claim 47.

61. A computer system having a processor arranged to perform a method according to claim 48.
